(19) United States
(12) Patent Application Publication
(10) Pub. No.: US 2026/0227980 A1
(43) Pub. Date: Aug. 6, 2026

(54) FLEXIBLE SYSTEM PROVISIONING USING A KNOWLEDGE GRAPH AND A CENTRAL CLOUD REPOSITORY

(71) Applicant: SAP SE, Walldorf (DE)

(72) Inventor: Prashant Telkar, Bangalore (IN)

(21) Appl. No.: 19/043,638

(22) Filed: Feb. 3, 2025

(51) Int. Cl. G06F 8/60

(52) U.S. Cl. CPC G06F 8/60

(57) ABSTRACT

The present disclosure involves systems, software, and computer implemented methods for system provisioning. One example method includes receiving a request for provisioning of a software solution. A knowledge graph is accessed that comprises a graph of object types of sample data and dependency information for the object types. The knowledge graph is traversed to identify object types and object dependencies included in the software solution. An interface is invoked to determine whether a data repository includes, for each identified object type, data for the identified object type. In response to determining that the data repository includes data for each identified object type, the interface is invoked to iteratively retrieve, in a dependency order determined based on the object dependencies of the identified object types, data from the data repository of each identified object type. Retrieved data is provided, in the dependency order, for deployment during provisioning of the software solution.

### TECHNICAL FIELD

The present disclosure relates to computer-implemented methods, software, and systems for system provisioning.

### BACKGROUND

Applications used for organizations can use master data (such as name and address) and transactional data (such as orders and bills). Transactional data typically references corresponding master data. For instance, a transactional object of type Order can refer to a master data object of type Customer. A given master data object can be referenced by one or more (or perhaps no) transactional objects. In some cases, data may be considered master data in one context and transactional data in another context. For example, insurance contract data may be considered transactional data with respect to a customer object but considered master data with respect to transactional insurance claim data.

### SUMMARY

The present disclosure involves systems, software, and computer implemented methods for system provisioning. An example method includes: receiving a request for provisioning of a software solution; accessing a knowledge graph for the software solution that comprises a graph of object types of sample data for the software solution and dependency information for the object types; traversing the knowledge graph to identify object types included in the software solution and object dependencies of identified object types; invoking an API (Application Programming Interface) to query a data repository to determine whether the data repository includes, for each identified object type, data for the identified object type; in response to determining that the data repository includes, for each identified object type, data for the identified object type, invoking the API to iteratively retrieve, in a dependency order determined based on the object dependencies of the identified object types, data from the data repository of each identified object type in a dependency order determined based on the object dependencies of the identified object types; and providing retrieved data, in the dependency order, for deployment during provisioning of the software solution.

Implementations may include one or more of the following features. The knowledge graph can include vectorized information for the object types and dependency information and traversing the knowledge graph comprises comparing information in the request to the vectorized information. In response to determining that the data repository does not include, for each of at least one first object type, data for the at least one first object type, a provisioning error message can be generated regarding missing dependent data for the at least one first object type and the provisioning error message can be provided in response to the request for provisioning of the software solution. Context information associated with the request can be identified and data can be retrieved from the data repository based on the context information. The context information can be or include a filter that specifies a subset of data for a particular customer. Retrieving data from the data repository based on the context information can include filtering the data in the data repository based on the filter. Data integrity checks can be performed on the data repository to determine whether the data repository includes data consistent with object dependencies in the knowledge graph. A visualization of the knowledge graph can be generated and provided for presentation on a user device. The knowledge graph can include nodes representing object types and edges representing relationships between object types. A first node can represent a master data object type and a second node can represent a transactional data object type that is a dependent object of the master data object type. A new object type can be identified for the software solution and the knowledge graph can be updated to include the new object type and dependency information for the new object type. The API can be an ODATA (Open Data Protocol) API.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for system provisioning.

FIG. 2 is a block diagram illustrating an example system for system provisioning.

FIG. 3 is a block diagram illustrating an example system for system provisioning.

FIGS. 4 and 5 illustrate example knowledge graphs.

FIG. 6 is a flowchart of an example method for system provisioning.

### DETAILED DESCRIPTION

In some systems, sample data can be bundled with enterprise applications during deployment of an initial system for a customer. However, bundling sample data with applications can result in various problems and challenges that can have substantial negative effects on customer system deployment and onboarding. For example, sample data may have various unknown or unforeseen issues which can result in triggering of activation errors that cause substantial delays and disruptions to system provisioning processes. Delays in system provisioning time spent on complex troubleshooting can adversely affect customer operations and hinder access to system or application features. Issues with sample data can cause a substantial volume of support incidents that result in substantial resource usage and adverse affect on customer satisfaction, experience, and operations.

To solve issues and challenges posed by the inclusion of sample data during customer system provisioning, an improved solution can be used that includes a cloud-based system that decouples sample data from enterprise applications. Such decoupling can provide a more agile and adaptive framework for provision of sample data. Moreover, the solution can result in streamlined system provisioning and elimination or reduction of activation errors during expedited customer onboarding processes.

The solution provides an alternative to conventional practices of bundling sample data within applications by providing a dynamic model in which sample data is stored in a dedicated cloud repository. The system can leverage ODATA (Open Data Protocol) APIs (Application Programming Interfaces) for seamless and consistent delivery of sample data to applications during deployment. In further detail, the solution can include a knowledge graph that maps and manages the dependencies and relationships between master and organizational data instances.

The solution can provide various other advantages. For example, the solution can provide ad-hoc capability that enables users to access and deploy sample data on-demand. The solution can mitigate the challenges associated with system provisioning delays and reduce activation errors by dynamically sourcing sample data from the cloud repository and ensuring sample data correctness and relevance. For example, through use of the knowledge graph, sample data integrity and dependencies can be continuously monitored resulting in proactive reduction of activation issues caused by missing or incompatible data relationships.

Furthermore, the isolation of sample data in the cloud can significantly reduce the occurrence of incidents related to sample data issues. With a centralized repository, robust version control and quality assurance measures can be implemented that ensure that deployed sample data is consistently accurate. Additionally, the knowledge graph itself can enhance troubleshooting by providing a clear, visual representation of data dependencies and potential points of failure, contributing to a more stable and reliable onboarding experience for customers.

With the solution, provisioning times can be drastically reduced, resulting in enhanced customer operational efficiency and enabling organizations to respond rapidly to customer demands. Activation errors, a persistent pain point in traditional approaches can be eliminated or substantially reduced, resulting in a smoother and more reliable onboarding process and reduction or elimination of technical resources that would otherwise be used for troubleshooting and error correction. Customer experience can thus be significantly improved, since users can seamlessly integrate sample data into applications without a hindrance of common issues associated with bundled data.

Moreover, the flexibility of the cloud-based solution enables organizations to scale effortlessly and adapt to evolving requirements. For instance, as deployed applications and systems are decoupled from the constraints of packaged sample data, updates and modifications can be implemented seamlessly, ensuring that customers always have access to the latest and most relevant sample datasets. The knowledge graph can further support scalability by providing real-time insights into data relationships and dependencies, allowing the system to adapt and evolve with minimal disruption.

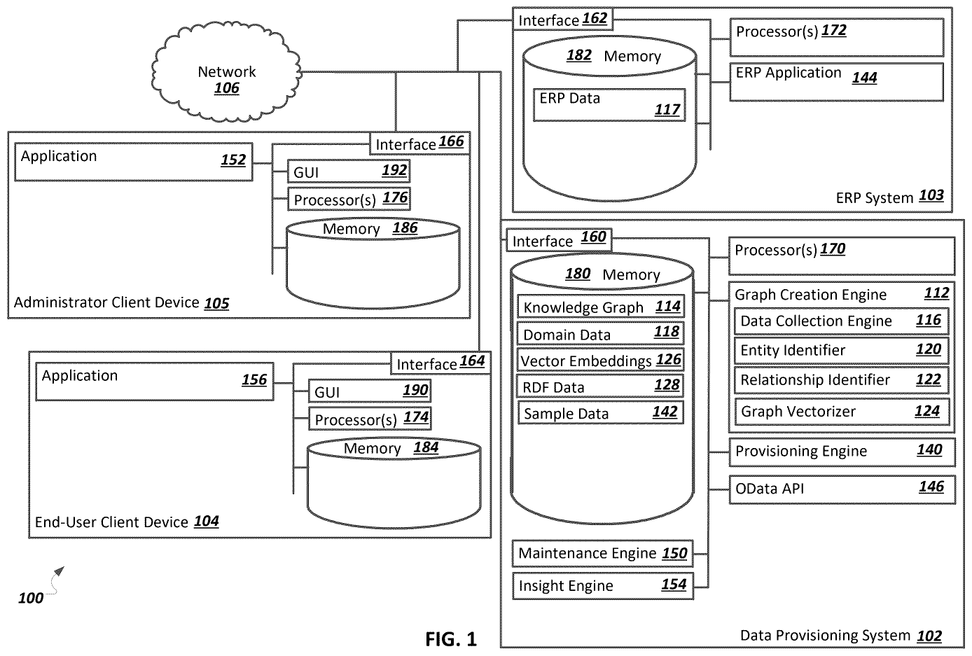

FIG. 1 is a block diagram illustrating an example system 100 for system provisioning. The system 100 includes a data provisioning system 102, an ERP (Enterprise Resource Planning) system 103, an end-user client device 104, an administrator client device 105, and a network 106. Although shown separately, in some implementations, functionality of two or more systems or servers may be provided by a single system or server. In some implementations, the functionality of one illustrated system, server, or component may be provided by multiple systems, servers, or components, respectively.

A graph creation engine 112 can be used to create a knowledge graph 114. The knowledge graph 114 can be created for a specific use case, application, service, or domain. For example, the knowledge graph 114 can correspond to a sell-from-stock domain or use case.

A data collection engine 116 can gather (or can be used to gather) domain data 118 from various sources (e.g., databases, API (Application Programming Interface) endpoints, existing documentation, etc.) for defining the knowledge graph 114 for the domain (or use case, application, or service) represented by the knowledge graph 114. The data collection engine 116 can gather (or can be used to gather) data from multiple types of sources to ensure data diversity including data from different perspectives for capturing different aspects of the domain (or use case, application, or service). For example, the data collection engine 116 can use ETL (Extract, Transform, Load) pipelines to pull data from source systems such as the ERP system 103) and transform extracted data to a format used by a schema defined for the graph database. For example, the data collection engine 116 can receive copies of ERP data 117 from the ERP system 103.

The schema for the graph database can support nodes that correspond to entities and edges that correspond to relationships between entities. For example, an entity identifier 120 can identify (or can be used to identify) data entities (e.g., customers, products, accounts) and entity attributes and constraints in the domain data 118. The entity identifier 120 can classify (or can be used to classify) identified entities into categories representing, for example, organizational structures and/or master data types.

A relationship identifier 122 can identify (or can be used to identify) relationships between entities. Relationship types can include, for instance, dependency, association, and/or hierarchical relationships. For example, a depends-on relationship can connect two entities where one entity uses data from the other entity. The graph creation engine 112 can use the identified entities and entity relationships to define the structure of the knowledge graph 114 as an ontology that encompasses identified entities and relationships. The graph creation engine 112 can build the knowledge graph 114, for example, as or in a graph database (e.g., Neo4j, Amazon Neptune, or other graph databases), by modeling, in the graph database, entities as nodes and relationships as edges.

A graph vectorizer 124 can convert the knowledge graph 114 into vector embeddings 126. The vector embeddings 126 can be used in various applications, such as NLP (Natural Language Processing), machine learning, etc., as described in more detail below. Converting the knowledge graph 114 to the vector embeddings 126 can be performed using various techniques and technologies.

For example, one approach for converting the knowledge graph 114 to the vector embeddings 126 can include using RDF (Resource Description Framework) technologies and creating RDF data 128 from the knowledge graph 114 as an intermediate data representation. As another example, the knowledge graph 114 itself may be represented in an RDF format and the graph vectorizer 124 can directly convert the RDF data of the knowledge graph 114 to the vector embeddings 126.

RDF is a model for data interchange that supports representing information about resources in a structured way. RDF uses a subject-predicate-object tuple format that can be used for describing relationships in the knowledge graph 114. The graph vectorizer 124 can define, in or for the RDF data 128, an RDF schema for representing entities and relationships.

The graph vectorizer 124 can generate, in the RDF data 128, RDF tuples that model data in the knowledge graph 114. For instance, when a first entity is related to a second entity in the knowledge graph 114, the graph vectorizer 124 can create, in the RDF data 128, a tuple that includes a resource subject of the first entity, a predicate that describes a relationship type (e.g., depends-on) that involves the first entity, and an object that defines the other entity (e.g., the second entity) to which the subject (e.g., first entity) is related.

The graph vectorizer 124 can convert the RDF data 128 into the vector embeddings 126 using different approaches, tools, or technologies, such a Node2Vec tool, a graph neural network, RDFLib Python library, Apache Jena framework, RDF query languages, etc. The vector embeddings 126 can be used in various applications, such as machine learning, classification, recommendation, similarity search, etc.

For example, a provisioning engine 140 can search the knowledge graph 114 (e.g., by searching the vector embeddings 126) to identify object types and object dependencies, of data in a sample data repository 142, for a provisioning request. For instance, the provisioning engine 140 can receive a request for provisioning of a software solution (e.g., an ERP application 144, for a particular customer). The provisioning engine 140 can access the knowledge graph 114 and traverse the knowledge graph 114 to identify object types included in the software solution and object dependencies of identified object types. The provisioning engine 140 can invoke an API 146 (Application Programming Interface), such as an OData (Open Data Protocol) API, to query the sample data repository 142 to determine whether the sample data repository 142 includes, for each identified object type, data for the identified object type. The provisioning engine 140 can, in response to determining that the sample data repository 142 includes, for each identified object type, data for the identified object type, invoke the API 146 to iteratively retrieve, in a dependency order determined based on the object dependencies of the identified object types, data from the sample data repository of each identified object type. The provisioning engine 140 can provide retrieved data, in the dependency order, for deployment during provisioning of the software solution. For example, data can be provided to the ERP system 103 so that instances of respective objects can be created in or for the ERP application 144 based on sample data retrieved from the sample data repository 142. As another example, some or all sample data can be stored in or as the ERP data 117.

A maintenance engine 150 can perform various activities to maintain the knowledge graph 114 to ensure that the knowledge graph 114 remains relevant and accurate as system requirements and data evolves. For example, the maintenance engine 150 can perform activities relating to handling data changes and new data, version control, and integrity checking. The maintenance engine 150 can track changes to data entities over time and identify and perform updates on related entities as necessary, in response to changes in organizational structures and/or master data. For instance, the maintenance engine 150 can identify a change to a vendor entity and then identify impact and any necessary updates for related material and procurement data. In general, for each change to a data entity, the maintenance engine 150 can analyze impact on related nodes in the knowledge graph 114. As another example, in response to an update to a product dependency, the maintenance engine 150 can trace and implement impacts to associated customer and inventory nodes.

Regarding new data, the knowledge graph 114 can provide a scalable solution. As new entities emerge in the system, the knowledge graph 114 can be scalable in that new data entity nodes and corresponding relationships can be seamlessly added by the maintenance engine 150 to the knowledge graph 114. Therefore, the knowledge graph 114 can adapt to evolving system requirements without requiring substantial reconfiguration.

The maintenance engine 150 can perform version control activities in response to changes in the knowledge graph. For example, each entity update can be stored as a new version. The maintenance engine 150 can enable viewing of tracked changes that have occurred over time and rolling back to a previous version.

The maintenance engine 150 can also perform ongoing data integrity checks, including monitoring integrity of entities and relationships of the knowledge graph 114. The maintenance engine 150 can perform, for example, automated integrity checks to validate relationship connections in the knowledge graph 114. The automated integrity checks can enable detection of any broken or outdated relationships that could affect data provisioning. The maintenance engine 150 can auto correct broken relationships in some instances and/or can include an alerting feature that automatically notifies administrators (e.g., by sending a message to the administrator client device 105 for presentation in an application 152) regarding any detected inconsistencies or broken relationships in the knowledge graph 114.

An insight engine 154 can provide various insight-related activities and features with respect to the knowledge graph 114. For example, the insight engine 154 can provide various visualization and management tools that enable visualizing the knowledge graph 114, for example, in the application 152 or an application 156. A visualization of the knowledge graph 114 can present a clear view of data dependencies and relationships, which can enable streamlined troubleshooting and reduced disruption if any issue should occur during data provisioning.

As used in the present disclosure, the term “computer” is intended to encompass any suitable processing device. For example, although FIG. 1 illustrates a single data provisioning system 102, a single ERP system 103, a single end-user client device 104, and a single administrator client device 105, the system 100 can be implemented using multiple of such devices. The data provisioning system 102, the ERP system 103, the end-user client device 104, and the administrator client device 105 may be or include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, each illustrated device may be adapted to execute any operating system, including Linux, UNIX, Windows, Mac OS®, Java™, Android™, iOS or any other suitable operating system.

Interfaces 160, 162, 164, and 166 are used by the data provisioning system 102, the ERP system 103, the end-user client device 104, and the administrator client device 105, respectively, for communicating with other systems in a distributed environment—including within the system 100—connected to the network 106. Generally, the interfaces 160, 162, 164, and 166 each comprise logic encoded in software and/or hardware in a suitable combination and operable to communicate with the network 106. More specifically, the interfaces 160, 162, 164, and 166 may each comprise software supporting one or more communication protocols associated with communications such that the network 106 or interface's hardware is operable to communicate physical signals within and outside of the illustrated system 100.

The data provisioning system 102, the ERP system 103, the end-user client device 104, and the administrator client device 105 each include one or more processors 170, 172, 174, or 176, respectively. Each processor in the processors 170, 172, 174, or 176 may be a central processing unit (CPU), a blade, an application specific integrated circuit (ASIC), a field-programmable gate array (FPGA), or another suitable component. Generally, each processor in the processors 170, 172, 174, or 176 executes instructions and manipulates data to perform the operations of the respective device.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, Python, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The data provisioning system 102, the ERP system 103, the end-user client device 104, and the administrator client device 105 each include memory 180, 182, 184, or 186, respectively. In some implementations, a given device can include multiple memories. Each memory 180, 182, 184, or 186 may include any type of memory or database module and may take the form of volatile and/or non-volatile memory including, without limitation, magnetic media, optical media, random access memory (RAM), read-only memory (ROM), removable media, or any other suitable local or remote memory component. Each memory 180, 182, 184, or 186 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the respective device.

The end-user client device 104 and the administrator client device 105 may each generally be any computing device operable to connect to or communicate with the ERP system 103 and/or the data provisioning system 102 via the network 106 using a wireline or wireless connection. In general, the end-user client device 104 and the administrator client device 105 each comprise an electronic computer device operable to receive, transmit, process, and store any appropriate data associated with the system 100 of FIG. 1. The end-user client device 104 and the administrator client device 105 can include one or more client applications, including the application 156 or the application 152, respectively. A client application is any type of application that allows the end-user client device 104 or the administrator client device 105 to request and view content on the respective device. In some implementations, a client application can use parameters, metadata, and other information received at launch to access a particular set of data from the ERP system 103 or the data provisioning system 102. In some instances, a client application may be an agent or client-side version of the one or more enterprise applications running on an enterprise server (not shown).

The end-user client device 104 and the administrator client device 105 are each generally intended to encompass any client computing device such as a laptop/notebook computer, wireless data port, smart phone, personal data assistant (PDA), tablet computing device, one or more processors within these devices, or any other suitable processing device. For example, the end-user client device 104 and/or the administrator client device 105 may comprise a computer that includes an input device, such as a keypad, touch screen, or other device that can accept user information, and an output device that conveys information associated with the operation of the system 100, or the respective client device itself, including digital data, visual information, or a GUI (Graphical User Interface) 190 or 192, respectively.

The GUI 190 and the GUI 192 each interface with at least a portion of the system 100 for any suitable purpose, including generating a visual representation of the application 152 or the application 156, respectively. In particular, the GUI 190 and the GUI 192 may each be used to view and navigate various Web pages, or other user interfaces. Generally, the GUI 190 and the GUI 192 each provide a user with an efficient and user-friendly presentation of data provided by or communicated within the system 100. The GUI 190 and the GUI 192 may each comprise a plurality of customizable frames or views having interactive fields, pull-down lists, and buttons operated by the user. The GUI 190 and the GUI 192 each contemplate any suitable graphical user interface, such as a combination of a generic web browser, intelligent engine, and command line interface (CLI) that processes information and efficiently presents the results to the user visually.

There may be any number of end-user client devices 104 and administrator client devices 105 associated with, or external to, the system 100. For example, while the illustrated system 100 includes one end-user client device 104 and one administrator client device 105, alternative implementations of the system 100 may include multiples of such devices communicably coupled to the network 106, or any other number suitable to the purposes of the system 100. Additionally, there may also be one or more additional end-user client devices 104 and/or administrator client devices 105 external to the illustrated portion of system 100 that are capable of interacting with the system 100 via the network 106. Further, the term “client”, “client device” and “user” may be used interchangeably as appropriate without departing from the scope of this disclosure. Moreover, while the end-user client device 104 and the administrator client device 105 are each described in terms of being used by a single user, this disclosure contemplates that many users may use one computer, or that one user may use multiple computers.

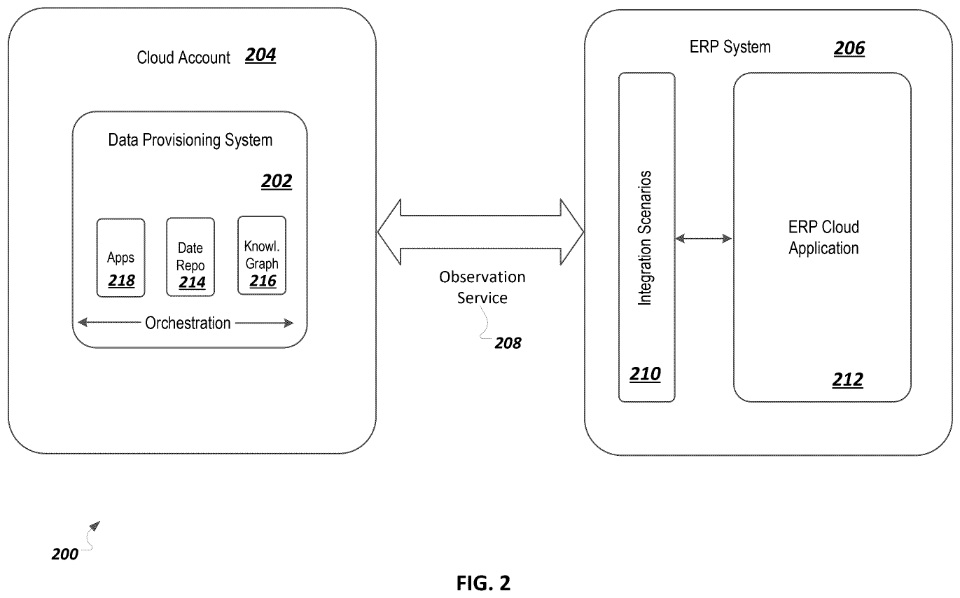

FIG. 2 is a block diagram illustrating an example system 200 for system provisioning. A data provisioning system 202 (which can be, for example the data provisioning system 102 of FIG. 1 and which can be a cloud service implemented as part of a cloud account 204) can provide data provisioning services for an ERP system 206 (or another type of system). The data provisioning system 202 can implement an observation service 208, for example, that listens for provisioning request events from the ERP system 206. Provisioning requests can occur as a result of deployment of integration scenarios 210 or as a result of some other type of trigger for deployment of a software solution that is part of the ERP system 206. For example, a customer may be deploying all or a portion of an ERP cloud application 212 and as part of deployment of the ERP cloud application 212 may wish to have sample data provided by the data provisioning system 202 provided as part of the deployment.

The data provisioning system 202 can provide sample data to the ERP system 206 (e.g., for an instance of the ERP system 206) from a data repository 214. The data provisioning system 202 can ensure, before providing sample data, that data in the data repository 214 is consistent with object types and object type relationships represented in a knowledge graph 216. The data provisioning system 202 can include various applications 218 that can provide functionality to create and define the knowledge graph 216, configure automatic processes that monitor integrity of the knowledge graph 216 (and the data repository 214 with respect to the knowledge graph 216), visualizations of the knowledge graph 216, providing of insights related to the knowledge graph 216, etc.

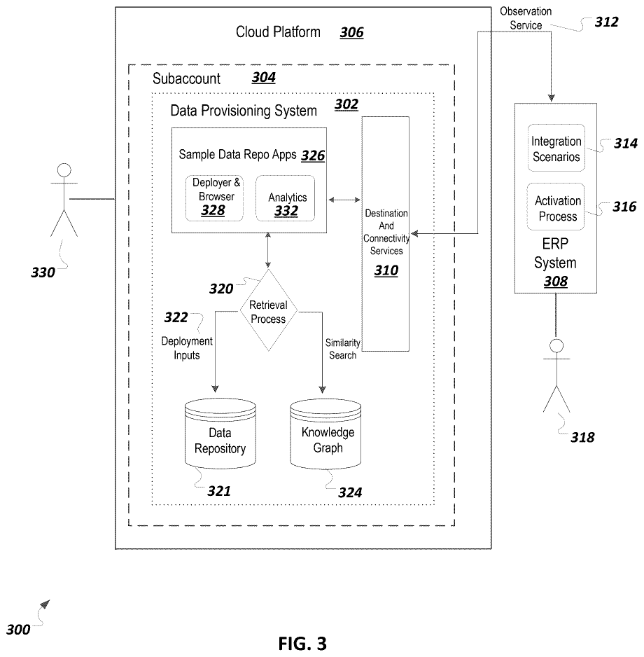

FIG. 3 is a block diagram illustrating an example system 300 for system provisioning. A data provisioning system 302 (which can be the data provisioning system 102 of FIG. 1 and/or the data provisioning system 202 of FIG. 2) can be a cloud service implemented as part of a cloud subaccount 304 of a cloud platform 306. The data provisioning system 302 can provide data provisioning services for an ERP system 308. The data provisioning system 302 can interface with the ERP system 308 using a set of destination and connectivity services 310, which can include an observation service 312 that listens for provisioning request events from the ERP system 308.

Provisioning requests from the ERP system 308 can be received by the data provisioning system 302 as a result of deployment of integration scenarios 314, as a result of a trigger of an activation process 316 (e.g., for an ERP application of the ERP system 308), or as a result of some other type of trigger for deployment of a software solution that is part of the ERP system 308, such as a request or event triggered by a user 318 (e.g., an administrator) of the ERP system 308.

In response to a provisioning request, the data provisioning system 302 can perform a retrieval process 320 to retrieve sample data from a data repository 321 that matches one or more deployment inputs 322. The deployment inputs 322 can include an indication of a software solution or application to be deployed, for example. In some cases, the deployment inputs 322 can include context information, e.g., for a particular customer for which the deployment is to occur. The context information can be a filter that specifies a certain subset of data to retrieve from the data repository 321. For instance, a customer may desire sample data only for a particular locale. The data provisioning system 302 can ensure, as part of the retrieval process 320, before providing sample data to the ERP system 308 (or to another deployment engine or service), that data in the data repository 321 is consistent with object types and object type relationships represented in a knowledge graph 324. The data provisioning system 302 can ensure that the data repository 321 includes data of object types associated with the software solution being deployed including data of any dependent objects of objects used for the solution. The knowledge graph 324 can represent object types and object type dependencies of objects associated with the ERP system 308, for example.

The data provisioning system 302 can include various applications 326. For example, the applications 326 can include a deployer and browser application 328 that enables triggering (e.g., by a user 330) of a deployment from the data provisioning system 302 side and viewing of data provisioning data and also a visualization of the knowledge graph 324. In some cases, the applications 326 can include analytics applications 332 that can provide insights related to the knowledge graph 324, past deployments, etc.

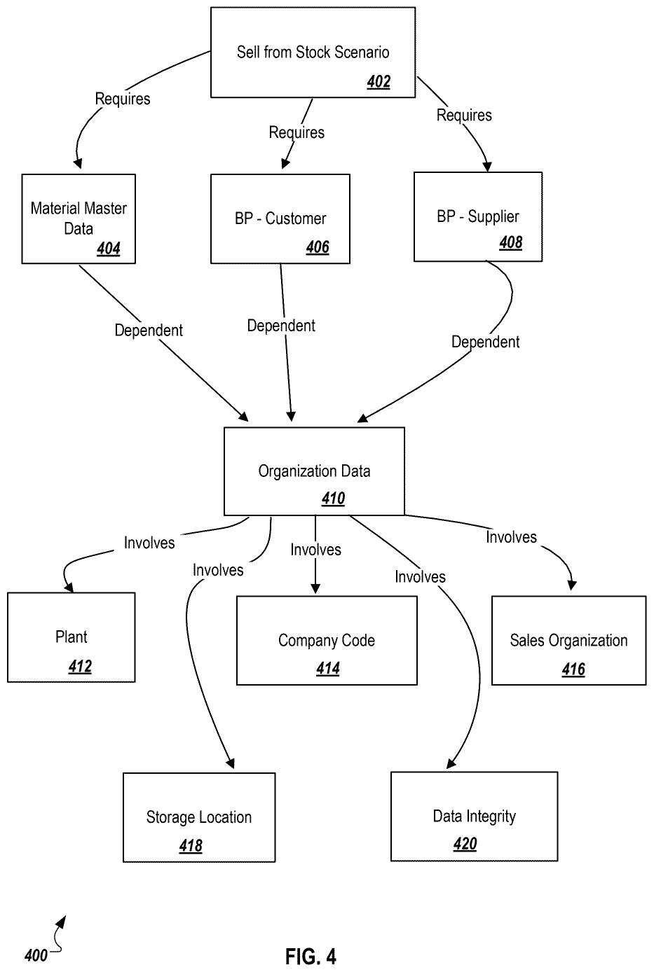

FIG. 4 illustrates an example knowledge graph 400. The knowledge graph 400 illustrates, for a sell from stock scenario node 402, relationships and dependencies that are managed, using the knowledge graph 400, during data provisioning. The sell from stock scenario requires a material master data object, a customer business partner object, and a supplier business partner object, as illustrated by nodes 404, 406, and 408, respectively, that are connected in the knowledge graph 400 to the sell from stock scenario node 402. Each of the material master data object, the customer business partner object, and the supplier business partner object can be dependent on organization data (e.g., as illustrated by dependencies edges from the nodes 404, 406, and 408 to an organization data node 410).

Nodes 412, 414, 416, 418, and 420 illustrate that organization data can involve plant data, company code data, sales organization data, storage location data, and data integrity data, respectively. As described herein, a data provisioning system can ensure that when sample data is provided for the sell from stock scenario, that required master data objects (e.g., a material master data object, a customer business partner object, and a supplier business partner object) are provided along with any other associated objects (e.g., various types of organization data objects) that are identified based on the dependencies defined by and illustrated in the knowledge graph 400.

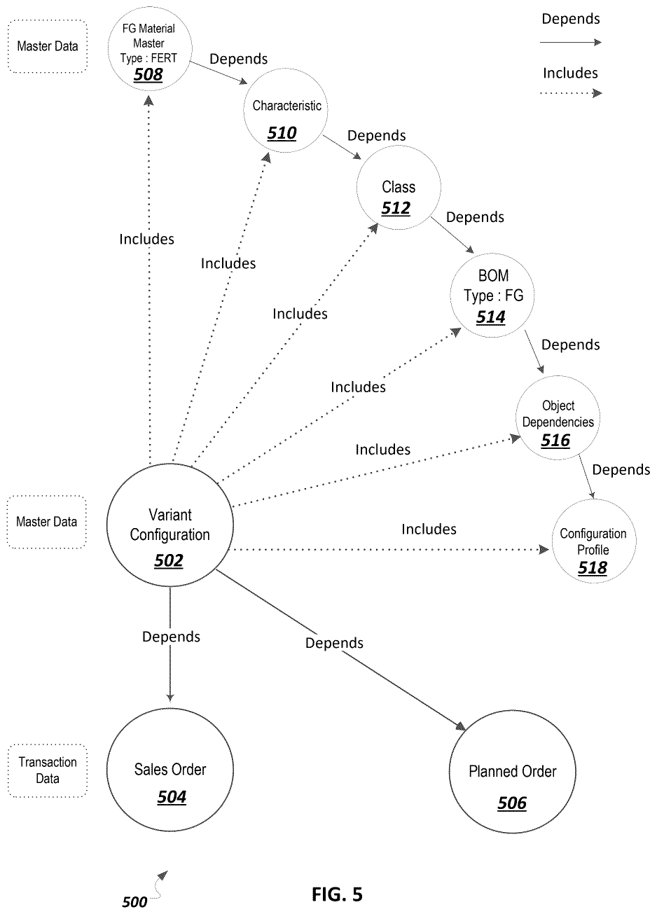

FIG. 5 illustrates an example knowledge graph 500. The knowledge graph 500 illustrates relationships and dependencies between master data and transaction data that are managed during data provisioning through use of the knowledge graph 500. If a software solution is to use, for example, an instance of variant configuration master data (e.g., represented as a node 502), that variant configuration master data object can require an associated transactional data object (e.g., an object to which the variant configuration applies). For example, the variant configuration master data object can depend on an instance of a sales order transactional data object (e.g., represented as a node 504) or a planned order transactional data object (e.g., represented as a node 506).

Additionally, variant configuration master data objects include instances of other types of master data. For example, the variant configuration master data object can include an FG (Finished Good) material object, a characteristic object, a class object, a BOM (Bill of Materials) object, an object dependencies object, and a configuration profile object, represented as nodes 508, 510, 512, 514, 516, and 518, respectively. Each of those objects are part of a dependency chain (e.g., starting at the node 508 and ending at the node 518). A data provisioning system can ensure that objects at the end of the dependency chain are created first, and then associated with a preceding object instance in the chain when the preceding object instance is created. For example, a configuration profile object can be created and then associated with an object dependencies object when the object dependencies object is created, and the object dependencies object can be associated with a BOM object when the BOM object is created, and so on, up until the FG material master object is created. Finally, the FG material master object can be associated with the created variant configuration master data object.

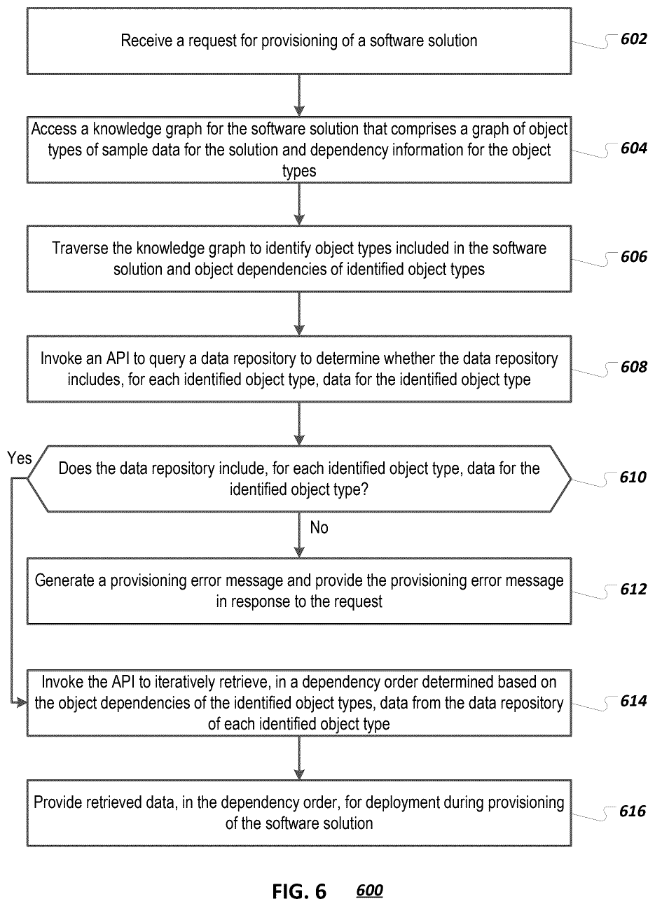

FIG. 6 is a flowchart of an example method for system provisioning. It will be understood that method 600 and related methods may be performed, for example, by any suitable system, environment, software, and hardware, or a combination of systems, environments, software, and hardware, as appropriate. For example, one or more of a client, a server, or other computing device can be used to execute method 600 and related methods and obtain any data from the memory of a client, the server, or the other computing device. In some implementations, the method 600 and related methods are executed by one or more components of the system 100 described above with respect to FIG. 1. For example, the method 600 and related methods can be executed by the data provisioning system 102 of FIG. 1.

At 602, a request is received for provisioning of a software solution. In some cases, context information associated with the request can be identified. The context information can be or include a filter that specifies a subset of sample data for the software solution for a particular customer.

At 604, a knowledge graph is accessed for the software solution that comprises a graph of object types of sample data for the solution and dependency information for the object types. The knowledge graph can include vectorized information for the object types and dependency information. The knowledge graph can include nodes representing object types and edges representing relationships between object types. As an example, a first node can represent a master data object type and a second node can represent a transactional data object type that is a dependent object of the master data object type.

At 606, the knowledge graph is traversed to identify object types included in the software solution and object dependencies of identified object types. Traversing the knowledge graph can include comparing information in the request to the vectorized information.

At 608, an API is invoked to query a data repository to determine whether the data repository includes, for each identified object type, data for the identified object type. The API can be an ODATA API.

At 610, a determination is made as to whether the data repository includes, for each identified object type, data for the identified object type.

At 612, in response to determining that the data repository does not include, for at least one identified object type, data for the at least one identified object type, a provisioning error is generated and provided in response to the request.

At 614, in response to determining that the data repository includes, for each identified object type, data for the identified object type, the API is invoked to iteratively retrieve, in a dependency order determined based on the object dependencies of the identified object types, data from the data repository of each identified object type. When the request includes a filter as context information, retrieving data from the data repository based on the context information can include filtering the data in the data repository based on the filter.

At 616, retrieved data is provided, in the dependency order, for deployment during provisioning of the software solution.

Data integrity checks can be performed on the data repository (e.g., periodically) to determine whether the data repository includes data consistent with object dependencies in the knowledge graph. In some cases, a visualization of the knowledge graph can be generated and provided for presentation on a user device. In some cases, a new object type can be identified for the software solution and the knowledge graph can be updated to include the new object type and dependency information for the new object type.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
receiving a request for provisioning of a software solution;
accessing a knowledge graph for the software solution that comprises a graph of object types of sample data for the software solution and dependency information for the object types;
traversing the knowledge graph to identify object types included in the software solution and object dependencies of identified object types;
invoking an API (Application Programming Interface) to query a data repository to determine whether the data repository includes, for each identified object type, data for the identified object type;
in response to determining that the data repository includes, for each identified object type, data for the identified object type, invoking the API to iteratively retrieve, in a dependency order determined based on the object dependencies of the identified object types, data from the data repository of each identified object type in a dependency order determined based on the object dependencies of the identified object types; and
providing retrieved data, in the dependency order, for deployment during provisioning of the software solution.

2. The computer-implemented method of claim 1, wherein the knowledge graph includes vectorized information for the object types and dependency information and traversing the knowledge graph comprises comparing information in the request to the vectorized information.

3. The computer-implemented method of claim 1, wherein in response to determining that the data repository does not include, for each of at least one first object type, data for the at least one first object type, the method comprises:
generating a provisioning error message regarding missing dependent data for the at least one first object type; and
providing the provisioning error message in response to the request for provisioning of the software solution.

4. The computer-implemented method of claim 1, further comprising:
identifying context information associated with the request; and
retrieving data from the data repository based on the context information.

5. The computer-implemented method of claim 4, wherein:
the context information comprises a filter that specifies a subset of data for a particular customer; and
retrieving data from the data repository based on the context information comprises filtering the data in the data repository based on the filter.

6. The computer-implemented method of claim 1, further comprising performing data integrity checks on the data repository to determine whether the data repository includes data consistent with object dependencies in the knowledge graph.

7. The computer-implemented method of claim 1, further comprising:
generating a visualization of the knowledge graph; and
providing the visualization of the knowledge graph for presentation on a user device.

8. The computer-implemented method of claim 1, wherein the knowledge graph includes nodes representing object types and edges representing relationships between object types.

9. The computer-implemented method of claim 8, wherein a first node represents a master data object type and a second node represents a transactional data object type that is a dependent object of the master data object type.

10. The computer-implemented method of claim 1, further comprising:
identifying a new object type for the software solution; and
updating the knowledge graph to include the new object type and dependency information for the new object type.

11. The computer-implemented method of claim 1, wherein the API is an ODATA (Open Data Protocol) API.

12. A computer-implemented system comprising:
one or more computers; and
a computer-readable medium coupled to the one or more computers having instructions stored thereon which, when executed by the one or more computers, cause the one or more computers to perform operations comprising:
receiving a request for provisioning of a software solution;
accessing a knowledge graph for the software solution that comprises a graph of object types of sample data for the software solution and dependency information for the object types;
traversing the knowledge graph to identify object types included in the software solution and object dependencies of identified object types;
invoking an API (Application Programming Interface) to query a data repository to determine whether the data repository includes, for each identified object type, data for the identified object type;
in response to determining that the data repository includes, for each identified object type, data for the identified object type, invoking the API to iteratively retrieve, in a dependency order determined based on the object dependencies of the identified object types, data from the data repository of each identified object type in a dependency order determined based on the object dependencies of the identified object types; and
providing retrieved data, in the dependency order, for deployment during provisioning of the software solution.

13. The computer-implemented system of claim 12, wherein the knowledge graph includes vectorized information for the object types and dependency information and traversing the knowledge graph comprises comparing information in the request to the vectorized information.

14. The computer-implemented system of claim 12, wherein in response to determining that the data repository does not include, for each at least one first object type, data for the at least one first object type, the operations further comprise:
generating a provisioning error message regarding missing dependent data for the at least one first object type; and
providing the provisioning error message in response to the request for provisioning of the software solution.

15. The computer-implemented system of claim 12, the operations further comprising:
identifying context information associated with the request; and
retrieving data from the data repository based on the context information.

16. The computer-implemented system of claim 15, wherein:
the context information comprises a filter that specifies a subset of data for a particular customer; and
retrieving data from the data repository based on the context information comprises filtering the data in the data repository based on the filter.

17. A computer program product encoded on a non-transitory storage medium, the product comprising non-transitory, computer readable instructions for causing one or more processors to perform operations comprising:
receiving a request for provisioning of a software solution;
accessing a knowledge graph for the software solution that comprises a graph of object types of sample data for the software solution and dependency information for the object types;
traversing the knowledge graph to identify object types included in the software solution and object dependencies of identified object types;
invoking an API (Application Programming Interface) to query a data repository to determine whether the data repository includes, for each identified object type, data for the identified object type;
in response to determining that the data repository includes, for each identified object type, data for the identified object type, invoking the API to iteratively retrieve, in a dependency order determined based on the object dependencies of the identified object types, data from the data repository of each identified object type in a dependency order determined based on the object dependencies of the identified object types; and
providing retrieved data, in the dependency order, for deployment during provisioning of the software solution.

18. The computer program product of claim 17, wherein the knowledge graph includes vectorized information for the object types and dependency information and traversing the knowledge graph comprises comparing information in the request to the vectorized information.

19. The computer program product of claim 17, wherein in response to determining that the data repository does not include, for each at least one first object type, data for the at least one first object type, the operations further comprise:
generating a provisioning error message regarding missing dependent data for the at least one first object type; and
providing the provisioning error message in response to the request for provisioning of the software solution.

20. The computer program product of claim 17, the operations further comprising:
identifying context information associated with the request; and
retrieving data from the data repository based on the context information.
